(19) United States
(12) Patent Application Publication
(10) Pub. No.: US 2006/0290920 A1
(43) Pub. Date: Dec. 28, 2006

(54) Method for the calibration of a distance image sensor

(75) Inventors: Nico Kämpchen, Ulm (DE); Matthias Bühler, Nellingen (DE); Klaus Dietmayer, Ulm (DE); Ulrich Lages, Hamburg (DE)

Correspondence Address: HARNESS, DICKEY & PIERCE, P.L.C., P.O. BOX 828, BLOOMFIELD HILLS, MI, 48303, US

(73) Assignee: IBEO Automobile Sensor GmbH, Hamburg (DE)

(21) Appl. No.: 11/176,776

(22) Filed: Jul. 7, 2005

(30) Foreign Application Priority Data
Jul. 8, 2004 (DE) 10 2004 033 114.6

(51) Int. Cl. G01B 11/26; G01C 3/08

(52) U.S. Cl. 356/139.04; 356/4.01; 356/139.07

(57) ABSTRACT

A method for the at least partial calibration of a distance image sensor for electromagnetic radiation mounted on a vehicle is described by means of which a detection range along at least one scanned area can be scanned and a corresponding distance image can be detected in relation to an alignment of the scanned area or of the distance image sensor relative to the vehicle. Distances between the distance image sensor and regions on at least one calibration surface are found by means of the distance image sensor and a value for a parameter which at least partly describes the alignment is determined using the distances that are found.

### CROSS-REFERENCE TO RELATED APPLICATIONS

This application claims the benefit of German Application No. 102004033114.6, filed Jul. 8, 2004. The disclosure of the above application is incorporated herein by reference.

### FIELD OF THE INVENTION

The present invention relates to a method for the calibration of a distance image sensor for electromagnetic radiation mounted on a vehicle by means of which a detection range along at least one scanned area can be scanned and a corresponding distance image can be detected.

### BACKGROUND OF THE INVENTION

Distance image sensors are basically known. With them distance images of their detection range can be detected, with the distance image points of the distance images containing data relative to the position of the correspondingly detected points or regions on articles and in particular with reference to the distance from the distance image sensor. The detection range thereby frequently includes at least one scanned area which will be understood to mean, in the context of the invention, an area on which or in which the points or regions on articles can be detected.

An example for such a distance image sensor is a laser scanner which swings a pulsed laser beam through its detection range and detects rays of the laser beam which are thrown back from articles in angularly resolved manner. The distance can be determined from the transit time of the laser pulses from their transmission up to the detection of components of the laser pulses thrown back from articles. The swung laser beam and the reception range from which thrown back radiation can be received and detected by a detector of the laser scanner hereby define the scanned area.

Such distance image sensors can advantageously be used for the monitoring of a monitoring region in front of alongside and/or behind a motor vehicle. In order to be able to precisely determine the position of detected articles relative to the vehicle the position and alignment of the distance image sensor and thus also of the scanned area relative to the vehicle must be precisely known. As a result of imprecise installation the distance image sensor can however be rotated relative to the longitudinal axis, vertical axis and/or transverse axis of the vehicle so that the alignment of the distance image sensor relative to the vehicle does not meet the specification. In order to be able to at least partly compensate for such deviations by adjustment or measures during the processing of the data of the distance image sensor it is desirable to be able to determine its alignment as precisely as possible. Corresponding problems can occur when using video sensors, such as video cameras for example.

### SUMMARY OF THE INVENTION

The present invention is thus based on the object of making available a method of the above-named kind by means of which an at least partial calibration can be carried out with good accuracy with respect to the alignment of the distance image sensor relative to the vehicle.

The object is satisfied by a method having the features of claim 1.

In the method of the invention for the at least partial calibration of a distance image sensor for electromagnetic radiation mounted on a vehicle, by means of which a detection range along at least one scanned area can be scanned and a corresponding distance image can be detected in relation to an alignment of the scanned area or of the distance image sensor relative to the vehicle, in distances between the distance image sensor and regions on at least one calibration surface are found by means of the distance image sensor and a value for a parameter which at least partly describes the alignment is determined using the distances that are found.

As initially mentioned the term distance image sensor for electromagnetic radiation will be understood, in the context of the invention, as a sensor by means of which distance images of the detection region can be detected using electromagnetic radiation which contain data with reference to the spacing of article points which are detected from the distance image sensor and/or to reference points fixedly associated therewith. For example corresponding radar sensors can be used.

Laser scanners are preferably used which sense the detection region with optical radiation, for example electromagnetic radiation in the infrared range, in the visible range or in the ultraviolet range of the electromagnetic spectrum. In particular, laser scanners can be used which move, preferably swing, a pulsed laser beam through the detection region and detect radiation thrown back or reflected back from articles. The distance can be detected from the pulse transit time from the distance image sensor to the article and back to the distance image sensor.

The distance image sensor has at least one scanned area along which articles can be detected. The scanned area can for example be defined in a laser scanner by the transmitted scanning beam and optionally its movement and/or by the detection range of the laser scanner for the radiation thrown back from detected articles. The position of the scanned area is fixed relative to the distance image sensor by the layout and/or optionally by an operating mode of the distance image sensor and is preferably known. The scanned area does not have to be a plane, this is however preferably the case.

For the at least partial determination of the alignment of the distance image sensor and/or of the scanned area at least one calibration surface is used in accordance with the invention. A calibration surface will in particular also be understood to mean a surface section of a larger surface what is used for the calibration.

The alignment of the distance image sensor or of the scanned area will be understood in accordance with the invention to mean the orientation of the distance image sensor or of the scanned area and the angular position of at least one reference axis of the distance image sensor or of a reference direction of the scanned surface at least approximately along the scanned surface relative to the vehicle and/or to a corresponding reference system. In this connection the orientation of the scanned area to the vehicle would in particular be understood as the orientation of a normal vector to the scanned area at a predetermined position relative to a vehicle plane determined by the longitudinal and transverse axes of the vehicle or to a surface on which the vehicle is standing. The desired alignment of the sensor or of the scanned area relative to the sensor can basically be as desired, for example it can form an angle of 90° with the surface, the scanned area however preferably forms an angle of smaller than 15° to the surface in the desired alignment.

The alignment of the distance image sensor can thus be described with corresponding parameters or variables. For example, at least one corresponding angle or angle cosine can be used. In this connection at least two parameters are necessary for the full description of the orientation.

For the at least partial description of the orientation an orientation angle which at least partly reproduces the orientation can be used, in particular a pitch angle which reproduces the orientation of the scanned area or of the distance image sensor relative to the longitudinal axis of the vehicle and/or a roll angle which reproduces the orientation of the scanned area or of the distance image sensor relative to the transverse axis of the vehicle. With respect to the angular position, a yaw angle between a predetermined reference axis of the distance image sensor at least approximately along the scanned area and a corresponding and predetermined reference axis of the vehicle parallel to the longitudinal axis and the transverse axis of the vehicle can be used as the parameter which at least partly describes the alignment.

In accordance with the invention it is sufficient for only the value of a parameter which reproduces the alignment, for example of an orientation angle or a yaw angle to be determined. However, values for at least two parameters which reproduce the orientation are preferably determined. It is particularly preferred if, in addition, a parameter which reproduces the angular position is also determined.

In accordance with the invention distances are determined by means of the distance image sensor between the distance image sensor and regions on the calibration surface. By using the distances that are found, and optionally further parameters, the value of the parameter which at least partly reproduces the alignment is then determined.

Through the use of distance measurements which have a higher accuracy than angular measurements, in particular with laser scanners, it is possible to achieve a precise calibration in this way.

Further developments and preferred embodiments of the invention are described in the claims, in the description and in the drawings.

In order to increase the accuracy of the calibration a plurality of distance images can preferably be detected which are then averaged. In particular a time average can be formed. For this purpose the distance image points of the same scanned area which are detected during the plural scans are combined into a total distance image and jointly evaluated.

In order to obtain the highest possible accuracy during calibration, even when detecting only one distance image or only a few distance images, it is preferred for a calibration surface with a known shape to be used on which two adjacent regions along the scanned area can be detected in spatially resolved manner for the calibration by means of the distance image sensor. In this manner the alignment of the scanned area of the distance image sensor to the calibration surface can be more precisely determined using at least two corresponding distance image points of at least one individual distance image. In particular it is possible to form average values on the basis of a plurality of detected distance image points of an individual distance image and thus to at least partly compensate errors of the angular determination in laser scanners, whereby the accuracy of the calibration can be improved.

Furthermore, it is preferred that a distance image sensor is calibrated by means of which the detection range along at least two different scanned areas can be scanned. Such distance image sensors are in particular also suitable for the vehicle field because, through the use of two scanned areas, at least one distance image corresponding to a scanned area is as a rule available through the use of two scanned areas despite pitching movements of the vehicle. A laser scanner with at least two scanned areas is for example described in German patent application with the official file reference 101430060.4 the content of which is incorporated into the description by reference.

In this case it is, in particular, then preferred for a distance image sensor to be calibrated for which the position and/or alignment of the scanned area relative to a coordinate system of the distance image sensor is known, for coordinates to be determined in the coordinate system of a distance image sensor for distance image points of the detected distance image which are associated with the scanned area and for these coordinates to be used for the at least partial determination of the alignment. This procedure is particularly advantageous for distance image sensors in which no corresponding correction is provided, but rather the coordinates are only approximately determined in a coordinate system of the distance image sensor. To put this into practice one position in the scanned area can in particular be detected, which can then be converted by means of a known function into corresponding coordinates in the coordinate system. This further development is for example advantageous in distance image sensors having a plurality of scanned areas which are inclined relative to one another, at least section-wise, because here imprecision could otherwise arise through the relative inclination of the scanned areas to one another.

In accordance with a first alternative it is preferred, when using a distance image sensor with two scanned areas, for respectively detected regions in the two scanned areas to be jointly used for the at least partial determination of the alignment. In this way a particularly simple processing of the data can take place.

In accordance with a second alternative it is preferred for a value associated with the respective scanned area to be determined for the parameter which at least partly reproduces the alignment from the distances of detected regions on the calibration surface to the distance image sensor for each of the scanned areas and for a value for the parameter which at least partly reproduces the alignment of the distance image sensor to be found from the values associated with the scanned areas. In other words the alignments of the scanned areas are determined at least partly independently of one another, and the alignment of the distance image sensor itself or of a coordinate system of the distance image sensor is determined from these alignments. In this way a large accuracy can be achieved.

In order to enable a particularly simple calibration it is preferred for the calibration surface to be flat. In this case inaccuracies of the position of the calibration surfaces relative to the distance image sensor during calibration have only a relatively small influence.

For the determination of the orientation of the scanned area, which can for example be given by the orientation of a normal vector to the scanned area at a predetermined position on the scanned area, it is preferred for the regions of the calibration surface to be respectively inclined relative to the longitudinal or vertical axis of the vehicle in predetermined manner for the at least partial determination of an orientation of the scanned area or of the distance image sensor relative to the vehicle, in particular of a pitch angle and for a value for a parameter which at least partly reproduces the orientation, in particular the pitch angle to be determined from the detected distances of the regions detected by the distance image sensor in dependence on their inclinations. The alignment of the calibration surface can basically be directed in accordance with the desired position of the scanned area with reference to the vehicle. It preferably forms an angle of less than 90° with this. In particular, the calibration surface can be inclined relative to a planar surface on which the vehicle stands during the detection of the distance image or during the calibration. In this manner the distance of the intersection of the scanned area with the calibration surface from the surface and/or from a corresponding plane of the vehicle coordinate system or an inclination of the scanned area in the region of the calibration surface relative to the surface and/or to the corresponding plane of the vehicle coordinate system can be determined solely by distance measurements, which, with laser scanners for example, have a high accuracy compared with angle measurements. The determination does not need to take place on the basis of only one corresponding distance image point, but rather reference points can also be found from detected distance image points which can then be used for the actual determination of the height and/or inclination.

For the at least partial determination of the orientation of the scanned area or of the distance image sensor it is then particularly preferred for a distance of the calibration surface in the region of the scanned area to be determined by the distance image sensor from at least two detected spacings of the regions of the calibration surface and for a value for a parameter which at least partly reproduces the orientation of the scanned area or of the distance image sensor, in particular the pitch angle, to be determined using the determined spacing of the calibration surfaces. In this manner a compensation of measurement errors can in particular take place which increases the accuracy of the calibration.

If only one calibration surface is used in a predetermined region of the scanned area then its distance from the distance image sensor must be known.

If a distance image sensor with at least two scanned areas is used it is preferred for a position of an intersection of the scanned area with the calibration surface in a direction orthogonal to a surface on which the vehicle stands to be determined from distance image points of different scanned areas corresponding to the same calibration surface or for an inclination of at least one of the scanned areas relative to the surface to be found in the direction from the distance image sensor to the calibration surface. The distance of the calibration surface from the distance image sensor does not then need to be known.

Alternatively, it is preferred for two calibration surfaces, which are arranged in a predetermined position relative to one another, to be used for the at least partial determination of the orientation, in particular of the pitch angle, with the regions of the calibration surfaces used for the calibration being inclined in a different, predetermined, manner relative to the longitudinal or vertical axis of the vehicle, for distances between the distance image sensor and regions on the calibration surfaces close to the scanned area to be determined by means of the distance image sensor and for differences of the distances that are found to be used for the determination of a value of a parameter, in particular of the pitch angle, which at least partly reproduces the orientation of the scanned area or of the distance image sensor. The reference to the calibration surfaces being adjacent will in particular be understood to mean that these are arranged so closely alongside one another, that an inclination of the scanned area in the direction of a beam starting from the distance image sensor in the scanned area can be determined. Differences can in particular be used as distinctions. The calibration surfaces can in this respect be physically separated or connected to one another or optionally formed in one piece. The inclinations of the calibration surfaces are in this respect not the same, they are preferably inclined in opposite directions.

In order to be able to fully determine the orientation it is preferred for at least two calibration surfaces which are spaced apart from one another in a direction transverse to a beam direction of the distance image sensor to be used for the determination of the orientation, with regions being present on the calibration surfaces which are respectively inclined in a predetermined manner relative to the longitudinal axis or the vertical axis of the vehicle.

In this connection it is particularly preferred for an angle between connection lines between the calibration surfaces and the distance image sensor to lie between 5° and 175°. In this manner a precise determination of the orientation in directions approximately transverse to a central beam of the scanned area is possible.

A value of a parameter which at least partly describes the orientation of the distance image sensor or of the scanned area can basically be preset and the other value can be determined with the method of the invention. It is however preferred for the values of the parameters which describe the orientation to be found in dependence on one another. In this way a full calibration with respect to the orientation is possible in a simple manner.

In order to be able to determine an angle between the longitudinal axis of the vehicle and a reference direction in the scanned area or a reference direction of the distance image sensor with a rotation at least approximately about the vertical axis of the vehicle or about a normal to the scanned area in the plane of the vehicle or in the scanning plane it is preferred for at least calibration surface whose shape and alignment relative to a reference direction of the vehicle is predetermined to be used for the determination of a rotation of a reference direction in the scanned area or of a reference direction of the distance image sensor at least approximately about the vertical axis of the vehicle or about a normal to the scanned area; for the positions of at least two regions on the calibration surface to be determined by means of the distance image sensor and for a value of a parameter which reproduces an angle of the rotation, in particular of a yaw angle to be found in dependence on the positions that are determined. In this manner, for the determination of the angle or of the parameter it is not only an angular measurement which is used but rather distance measurements which are also used, which significantly increases the accuracy. The calibration surface is preferably aligned orthogonal to the surface on which the vehicle stands.

In order to increase the accuracy of the calibration it is particularly preferred for two calibration surfaces to be used the shape of which is predetermined and which are inclined relative to one another in a plane parallel to a surface on which the vehicle stands, with the alignment of at least one of the calibration surfaces relative to the reference direction of the vehicle being preset, for the positions of at least two regions on each of the calibration surfaces in each case to be determined by means of the distance image sensor and for the value of the parameters to be determined in dependence on the positions. The inclination of the calibration surfaces relative to one another does not need to be the same for all sections of the calibration surface. Here also it is preferred for the calibration surfaces to be aligned orthogonal to the surface on which the vehicle stands.

In accordance with the above method alternatives the angle, i.e. the yaw angle can also be determined in that the direction of the calibration surfaces parallel to the surface is compared to that of the longitudinal axis of the vehicle. It is however preferred for two calibration surfaces to be used the shape of which and the position of which relative to one another and at least partly to the vehicle is preset and which are inclined relative to one another in the sections in the direction of the surface on which the vehicle stands, for at least two distance image points to be detected on each of the calibration surfaces by means of the distance image sensor and for the position of a reference point set by the calibration surfaces to be determined on the basis of the detected positions of the distance image points, of the shape of the calibration surfaces and the relative positions of the calibration surfaces relative to one another and to the vehicle and for it to be set in relationship with a predetermined desired position. In this manner the accuracy of the calibration can be further increased. The detected position can for example be set in relationship with the desired position by using a formula, the utility of which presupposes the desired position.

For this purpose it is particularly preferred for contour lines to be found on the calibration surfaces by means of the detected distance image points and for the position of the reference point to be determined from the contour lines. In this manner measurement errors can be simply compensated.

In order to permit a simple evaluation of the distance images it is preferred for the calibration surfaces to be flat and for the reference point to lie on an intersection line of the planes set by the calibration surfaces.

For the calibration the vehicle is preferably aligned with its longitudinal axis such the reference point lies at least approximately on an extension of the longitudinal axis of the vehicle.

If only as few calibration surfaces as possible are to be used then these are preferably so designed and arranged that they simultaneously enable the determination of the orientation and of the yaw angle.

Frequently it is sensible to provide both a distance image sensor and also a video camera of a vehicle in order to be able to better monitor the region in front of and/or alongside and/or behind the vehicle. In order to be able the exploit the data of the video camera it is also necessary to provide a calibration for the video camera. It is thus preferred for a video camera for the detection of video images of at least a part of the detection range of the distance image sensor to be calibrated at least partly in relationship to an alignment relative to the distance image sensor and/or to the vehicle, in that the position of a surface for the video calibration is determined by means of the distance image sensor taking account of the calibration of the distance image sensor, in that the position of a calibration feature on the surface is determined for the video calibration by means of the video camera and in that the value of a parameter which at least partly reproduces the alignment is found from the position of the calibration feature in the video image and from the position of the surface for the video calibration. In this manner the vehicle does not need to be arranged in an exactly preset position relative to the surface used for the calibration. In this manner the vehicle does not need to be arranged in a precisely preset position relative to the surface used for the calibration. This is on the contrary determined by the distance image sensor which can take place with high accuracy after a calibration, which can basically take place in any desired manner. Any desired preset feature which can be extracted in a video image can be used as a calibration feature. Having regard to the alignment of the video camera the same general remarks apply as for the alignment of the distance sensor. In particular corresponding angles can be used for the description.

In order to enable a comparison of the position of the calibration feature in the video image with the position detected by means of the distance image sensor it is preferred for a position of the calibration feature in the image to be determined in dependence on position coordinates of the calibration feature determined by means of the distance image sensor using a rule for the imaging of beams in the three-dimensional space onto a sensor surface of the video camera, preferably by means of a camera model. In this manner a determination from the video image of a position of the calibration feature in the space can be avoided which can frequently only be carried out incompletely. The imaging rule which reproduces the imaging by means of the video camera can for example be present as a lookup table. Any desired models suitable for the respective video camera can be used as the camera model, for example hole camera models. For video cameras of a large angle of view other models can be used. A model for a omnidirectional camera is for example described in the publication by Micusik, B. and Pajdla T.: “Estimation of Omnidirectional Camera Model from Epipolar Geometry”, Conference on Computer Vision and Pattern Recognition (CVPR), Madison, USA, 2003 and “Omnidirectional Camera Model and Epipolar Geometry Estimation by RANSAC with Bucketing”, Scandinavian Conference on Image Analysis (SCIA), Göteborg, Sweden, 2003.

In order to obtain a particularly accurate determination of the position of the surface with the calibration feature it is preferred for the surface for the video calibration to be arranged in a known position relative to the calibration surfaces for the determination of a rotation of a reference direction in the scanned area or of a reference direction of the distance image sensor at least approximately about the vertical axis of the vehicle or about a normal to the scanned area and in particular for it to be associated with them.

In order to obtain a particularly simple calibration it is preferred for the calibration feature to be formed on one of the calibration surfaces.

The camera model uses parameters which must mainly still be determined. In accordance with a first alternative it is thus preferred for internal parameters of a camera model of the video camera to be determined prior to the calibration of the video camera with reference to the alignment. For this known methods can basically be used, for example using chessboard patterns in a predetermined position relative to the video camera. In accordance with a second alternative it is preferred for internal parameters of a camera model of the video camera to be determined by means of the calibration feature. For this purpose it can be necessary to use a plurality of calibration features.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 a schematic plan view on a vehicle with a distance image sensor and a video camera and calibration objects located in front of and/or alongside the vehicle,

FIG. 2 a schematic partial side view of the vehicle and one of the calibration objects in FIG. 1,

FIG. 3 a schematic perspective view of a first calibration object with first calibration surfaces,

FIG. 4 a schematic perspective view of a second calibration object with second calibration surfaces and a third calibration surface,

FIGS. 5A and 5B a schematic side view and plan view respectively of the vehicle of FIG. 1 with a coordinate system used in a method in accordance with a preferred embodiment of the invention,

FIG. 6 a schematic representation of a vehicle coordinate system and of a laser scanner coordinate system to illustrate the alignment of the laser scanner relative to angles describing the vehicle,

FIG. 7 a schematic perspective representation for the explanation of a camera model for the video camera in FIG. 1,

FIG. 8 a section from a distance image with image points which correspond to first calibration surfaces and of contour lines or auxiliary straight lines used in the method,

FIG. 9 a schematic side view of a first calibration object to explain the determination of the inclination of a scanned area of the distance image sensor in FIG. 1 along a predetermined direction in the scanned area,

FIG. 10 a schematic illustration of an intermediate coordinate system used in the method of the preferred embodiment of the invention for the determination of the yaw angle and of the vehicle coordinate system,

FIG. 11 a section from a distance image with image points which correspond to second calibration surfaces and with contour lines or auxiliary straight lines used in the method,

FIG. 12 a perspective view of second calibration surfaces with calibration features for use in a method in accordance with a further embodiment of the method of the invention,

FIG. 13 a plan view on the second calibration surfaces in FIG. 12 with a vehicle, and

FIG. 14 a side view of a first calibration surface for a method in accordance with a third preferred embodiment of the invention in accordance with FIG. 9.

### DETAILED DESCRIPTION OF THE PREFERRED EMBODIMENTS

The following description of the preferred embodiment(s) is merely exemplary in nature and is in no way intended to limit the invention, its application, or uses.

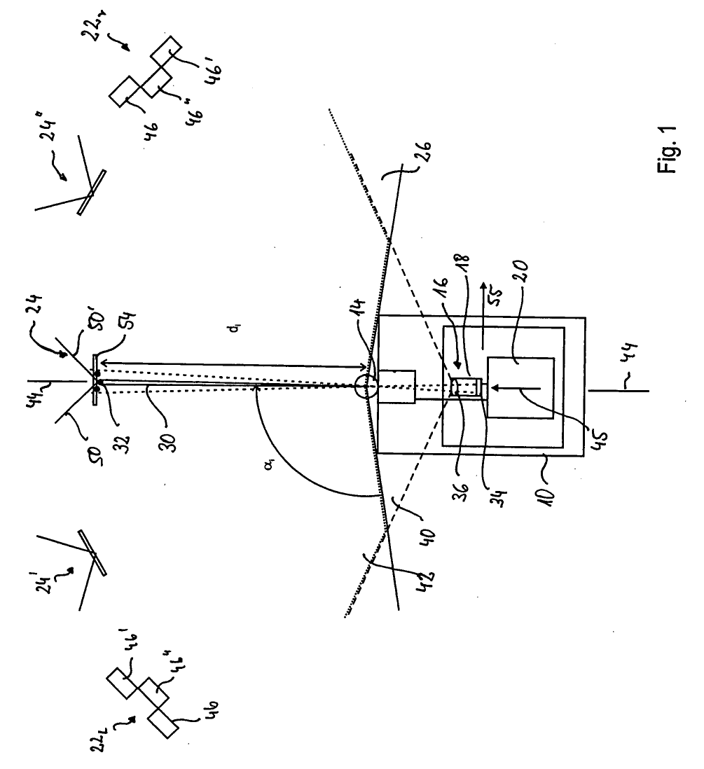

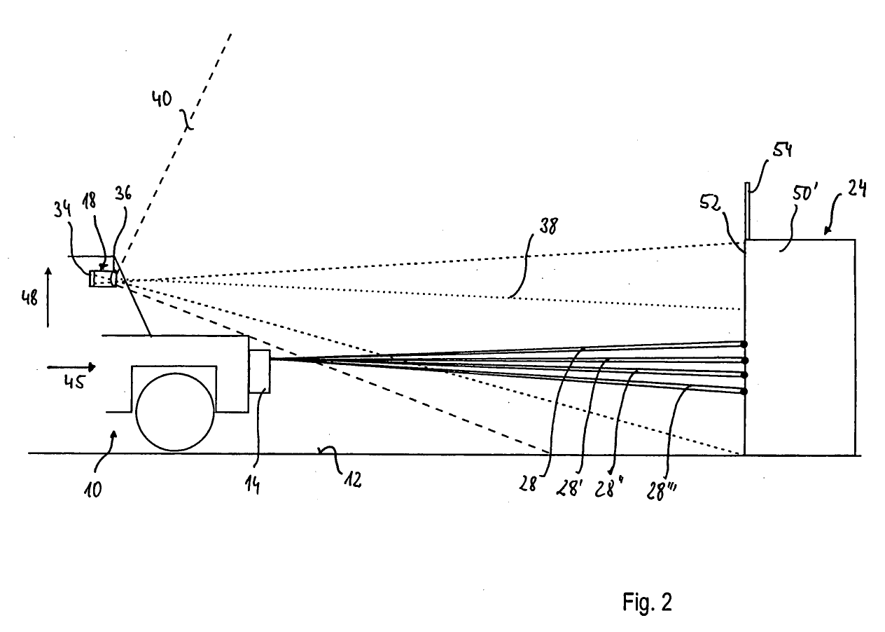

In FIGS. 1 and 2 a vehicle 10 which stands on a surface 12 carries a distance image sensor 14, in the example a laser scanner, which is mounted at the vehicle 10 for the monitoring of the region in front of the vehicle 10 at its front side and a video system 16 mounted at the vehicle 10 and having a monocular video camera 18. A data processing device 20 associated with the laser scanner 14 and the video system 16 are further located in the vehicle 10. First calibration objects 22₁ and 22ᵣ and also second calibration objects 24, 24′ and 24″ are located in the direction of travel in front of and alongside the vehicle 10.

The laser scanner 14 has a detection range 26 which is only partly shown in FIG. 1 and which covers an angle of somewhat more than 180°. The detection range 26 is only schematically illustrated in FIG. 1 and is in particular illustrated too small in the radial direction for the sake of better illustration. The detection range includes, as only schematically shown in FIG. 2, four fan-like scanned areas 28, 28′, 28″ and 28′″ which adopt a preset known position relative to one another and to the laser scanner 14. A corresponding laser scanner is for example disclosed in the above named German patent application. The calibration objects 22₁ and 22ᵣ and also 24, 24′ and 24″ are located in the detection range 26.

The laser scanner 14 scans its detection range 26 in a basically known manner with a pulsed laser beam 30 which is swung with a constant angular speed and which has a substantially rectangular elongate cross-section perpendicular to the surface 12 on which the vehicle stands in a position swung into the centre of the detection range 26. Detection is carried out in a manner matched to the swinging movement of the laser beam 30 in a rotating manner at constant time intervals Δt at times τᵢ in fixed angular ranges around a central angle αᵢ to determine whether the laser beam 30 is reflected from a point 32 or from a region of an article, for example of one of the calibration objects 22₁ and 22ᵣ as well as 24, 24′ and 24″. The index i thereby extends from 1 up to the number of the angular ranges in the detection range 26. Of these angular ranges only one angular range is shown in FIG. 1 which corresponds to the central angle αᵢ. In this connection the angular range is shown in exaggeratedly large form for the sake of a clearer representation. The light thrown back from articles is in this connection received by four correspondingly aligned detectors, the reception range of which is correspondingly be co-swung. Thus, as a result scanning takes place in the four scanned areas 28, 28′, 28″ and 28′″. With a section along the laser beam 30 the scanning plane sections are inclined to one another at small known angles, the size of which depends on the swung angle and is known. The detection range 26 thus includes, as can be recognized in FIG. 2, four scanned areas 28, 28′, 28″ and 28′″ which are two-dimensional apart from the divergence of the laser beam 30.

The distance image sensor spacing dᵢⱼ of the object point i is determined, in example in FIG. 1 of the object point 32 in the scanned area j, by the laser scanner 14 with reference to the transit time of the laser beam pulse. The laser scanner 14 thus detects, in addition to the scanned area j, the angle αᵢ and the distance dᵢⱼ detected at this angle as coordinates in a distance image point corresponding to the object point 32 of the object, that is to say the position of the object point 32 in polar coordinates. An object point is thus associated with each distance image point.

The set of distance image points detected during a scan forms a distance image in the sense of the present application.

The laser scanner 14 scans the first detection range 26 respectively in sequential scans so that a time sequence of scans and corresponding distance images arises.

The monocular video camera 18 of the video system 16 is a conventional black-white video camera with a CCD area sensor 34 and an image forming system which is mounted in the example in the region of the rear view mirror behind the windscreen of a vehicle 10. It has an image forming system which is schematically illustrated in FIGS. 1 and 2 as a simple lens 36, but actually consists of a lens system and forms an image of light incident from a video detection range 40 of the video system onto the CCD area sensor 34. An optical axis 38 of the video camera 18 is inclined relative to the scanned areas 28, 28′, 28″, 28′″ of the laser scanner 14 at a small angle which is shown to a exaggeratedly large degree in FIG. 2.

The CCD area sensor 34 has photodetection elements arranged in a matrix. Signals of the photodetection elements are read out, with video images with video image points being formed which initially contain the positions of the photodetection elements in the matrix or another characterization for the photodetection elements and in each case an intensity value corresponding to the intensity of the light received from the corresponding photodetection element. The video images are detected in this embodiment with the same rate at which distance images are detected by the laser scanner 14.

Light coming from an object, for example the calibration object 24, is imaged through the image forming system 36 onto the CCD area sensor 34. This is schematically indicated in FIGS. 1 and 2 for the outlines of the object, for example of the calibration object 24, by the short broken lines.

By means of a camera model for the video camera 18 the location of the CCD area sensor 34, formed by photodetection elements arranged in a matrix form, at which an object point is imaged can be calculated from the distance of the CCD area sensor 34 and of the image forming system 36 and also from the position and image forming characteristics of the image forming system 36, for example its focal width, from the position of the object point on the calibration object, for example of the object point 32.

A monitored region 42 is schematically illustrated by a dotted line in FIG. 1 and is given by the intersection of the detection ranges 26 of the laser scanners 14 and 40 of the video system 16 respectively.

The data processing device 20 is provided for the processing of the images of the laser scanner 14 and of the video system 16 and is connected for this purpose to the laser scanner 14 and to the video system 16. The data processing device 20 has amongst other things a digital signal processor programmed for the evaluation of the detected distance images and video images and a memory device connected to the digital signal processor. In another embodiment the data processing device can also have a conventional processor with which a computer program stored in the data processing device is designed for the evaluation of the detected images.

The first calibration objects 22ᵢ and 22ᵣ and also the second calibration objects 24, 24′ and 24″ are arranged in mirror symmetry with respect to a reference line 44, with the central one of the calibration objects 24 being arranged on the reference line 44. The vehicle 10 is arranged with its longitudinal axis 45 parallel to and in particular above the reference line 44.

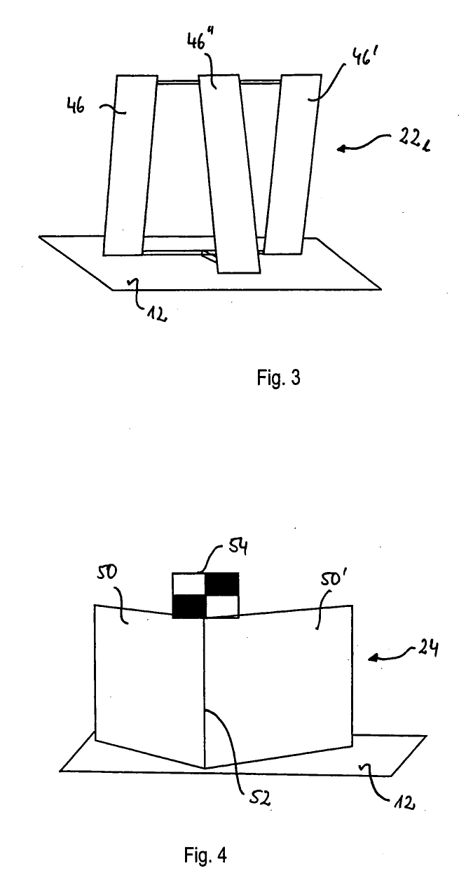

As is illustrated in FIGS. 1 and 3 the calibration objects 22₁ and 22ᵣ, which are designed in the same way, are arranged relative to the laser scanner 14 and to the reference line 44 at an angle of 45° to the left and right of the reference line 44 in the example, include three flat similarly dimensioned first calibration surfaces 46, 46′ and 46″ which are inclined at predetermined angles relative to the surface 12, in the example by approximately 30° and −30°. In this connection the first calibration surfaces 46 and 46′ are arranged parallel to one another while the first calibration surface 46″ subtends the same angle as the first calibration surfaces 46 and 46′, but with a different sign, to a normal to the surface 12 or to the vertical axis of the vehicle, so that in side view a shape results which resembles a gable roof or an isosceles triangle (see FIG. 9). The height H of the triangle and the spacing B of the first calibration surfaces 46, 46′ and 46″ at the surface 12 in the direction of the inclination of the first calibration surfaces are known. The first calibration surfaces 46, 46′ and 46″ are arranged adjacent to on another in such a way that on detection with the laser scanner 14 sequential distance image points lie in gap-free manner on the calibration object, i.e. on one of the first calibration surfaces 46, 46′ and 46″ but none in front of or behind it.

The second calibration objects 24, 24′ and 24″ which are likewise of the same design each include two second, flat, calibration surfaces 50 and 50′ aligned orthogonal to the surface 12 and thus parallel to the vertical axis 48 of the vehicle as well as being inclined to one another which intersect one another at an edge 52 (see FIGS. 1 and 3).

A third flat calibration surface 54 with a known calibration feature, in the example a chessboard-like pattern, is aligned symmetrical to the second calibration surfaces 50 and 50′ on the calibration object 24, 24′ and 24″ in each case over he edge 52 orthogonal to the surface 12. The centre point of the chessboard-like pattern lies with its centre point on the extension of the edge 52 at a known height orthogonal to the surface 12.

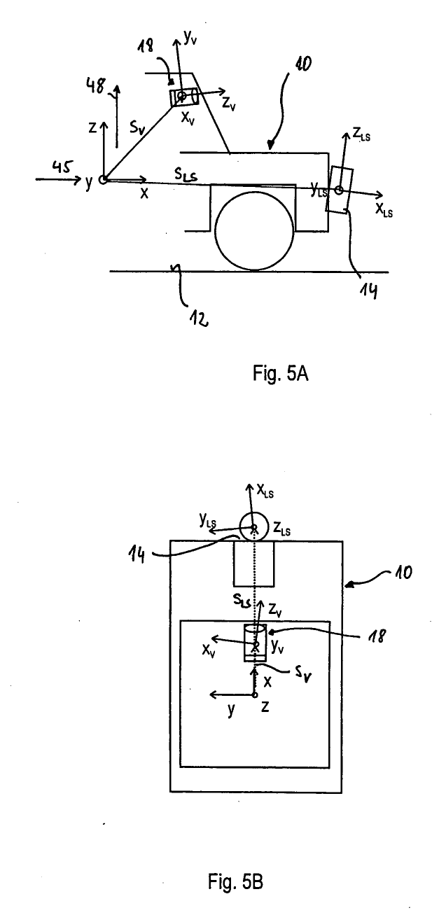

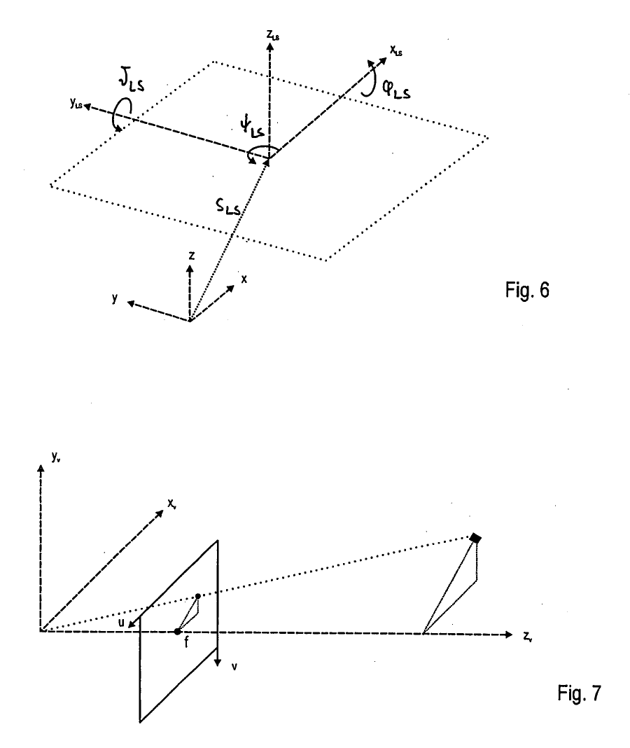

In the calibration method described in the following in accordance with a preferred embodiment of the invention a plurality of coordinate systems will be used (see FIGS. 5A, 5B and 6).

A Cartesian laser scanner coordinate system with axes x_{LS}, y_{LS}, z_{LS} is associated with the laser scanner 14, with the coordinates of the distance image points being given in the laser scanner coordinate system. The coordinates of objects can furthermore be specified in a Cartesian camera coordinate system with axes xᵥ, yᵥ and zᵥ fixedly associated with the video camera 18. Finally a Cartesian vehicle coordinate system is provided the x-axis of which is coaxial to the longitudinal axis 45 of the vehicle and the y- and z-axes of which extend parallel to the transverse axis 55 of the vehicle and to the vertical axis 48 of the vehicle respectively (see FIGS. 3A and 3B). Coordinates in the laser coordinate system are indicated by the index LS and those in the camera coordinate system are designated with the index V, whereas coordinates in the vehicle coordinate system do not have any index.

The origin of the laser scanner coordinate system is shifted relative to the origin of the vehicle coordinate system by a vector s_{LS} which is determined by the installed position of the laser scanner 14 on the vehicle 10 and is known.

The origin of the camera coordinate system is correspondingly shifted relative to the origin of the vehicle coordinate system by a vector sᵥ which is determined by the installed position of the video camera 18 on the vehicle 10 and is known.

The axes of the coordinate systems of the laser scanner coordinate system and of the camera coordinate system are in general rotated relative to the corresponding axes of the vehicle coordinate system. With the laser scanner coordinate system the scanned areas are also tilted in the same manner relative to the longitudinal and transverse axes of the vehicle. The orientation is described by the pitch angles ∂_{LS} and ∂_{V} and also the roll angles φ_{LS} and φ_{V}. Furthermore, the coordinate systems are rotated by a yaw angle Ψ_{LS} and Ψ_{V} respectively.

More precisely the laser scanner coordinate system proceeds from the vehicle coordinate system in that one first carries out a translation by the vector s_{LS} and then one after the other rotations by the yaw angle Ψ_{LS} about the shifted z-axis, by the roll angle φ_{LS} about the shifted and rotated x-axis and finally by the pitch angle ∂_{LS} about the shifted and rotated y-axis (see FIG. 6).

The transformation of a point with coordinates X, Y, Z in the vehicle coordinate system into coordinates X_{LX}, Y_{LS}, Z_{LS} can be described by a homogenous transformation with a rotation matrix R with entries rₘₙ and the translation vector s_{LS} with components s_{LSx}, s_{LSy} and s_{LSz}:

$$( \begin{matrix}{X}_{LS} \\ {Y}_{LS} \\ {Y}_{LS} \\ 1\end{matrix} ) = ( \begin{matrix}{r}_{11} & {r}_{12} & {r}_{13} & {s}_{LS x} \\ {r}_{21} & {r}_{22} & {r}_{23} & {s}_{LSy} \\ {r}_{31} & {r}_{32} & {r}_{33} & {s}_{LSz} \\ 0 & 0 & 0 & 1\end{matrix} ) \cdot ( \begin{matrix}X \\ Y \\ Z \\ 1\end{matrix} )$$

The components of the translation vector s_{LS} correspond to the coordinates of the origin of the laser coordinate system in the vehicle coordinate system.

The rotation matrix R is formed from the elementary rotational matrices

$${R}_{φ} = ( \begin{matrix}1 & 0 & 0 \\ 0 & cos {φ}_{LS} & - sin {φ}_{LS} \\ 0 & sin {φ}_{LS} & cos {φ}_{LS}\end{matrix} )$$

with a rotation about the x-axis

$${R}_{ϑ} = ( \begin{matrix}cos {ϑ}_{LS} & 0 & sin {ϑ}_{LS} \\ 0 & 1 & 0 \\ - sin {ϑ}_{LS} & 0 & cos {ϑ}_{LS}\end{matrix} )$$

with a rotation about the y-axis, and

$${R}_{ψ} = ( \begin{matrix}cos {ψ}_{LS} & - sin ψ {.}_{LS} & 0 \\ sin {ψ}_{LS} & cos {ψ}_{LS} & 0 \\ 0 & 0 & 1\end{matrix} )$$

with a rotation about the z-axis, by multiplication in accordance with the sequence of rotations. The angles are counted in each case in the mathematically positive sense.

The sequence of the rotation can be selected as desired must however be retained for the calibration in accordance with the choice. To this extent the sequence precisely defines the pitch, roll and yaw angles. In the example the rotation is first made about the z-axis, then about the x-axis and finally about the y-axis (see FIG. 6). There then results
R=R_{∂}R_{φ}R_{Ψ}

The alignment of the laser scanner 14 and of the scanned areas 28, 28′, 28″ and 28′″ can thus be described by the recitation of pitch, roll and yaw angles, with the pitch angle and the roll angle reproducing the orientation relative to the vehicle coordinate system or to the plane through the longitudinal and transverse axes 45 and 55 respectively.

Since the coordinates and data are present in the laser scanner coordinate system during the calibration, this coordinate system serves as the starting point. The coordinates are transformed stepwise into the vehicle coordinate system.

In this respect an intermediate coordinate system is used which is obtained from the vehicle coordinate system by translation by the vector S_{LS} and rotation about the translated z-axis by the yaw angle Ψ_{LS}. Coordinates in this coordinate system are designated with the index zs. The pitch and roll angles result from the determination of the orientation of the scanned areas, i.e. of the x_{LS}-y_{LS} plane of the laser coordinate system relative to the vehicle and/or intermediate coordinate system.

The yaw angle leads to a rotation of a reference direction of the laser scanner 14, for example of the x_{LS} axis in the x-y- or x_{ZS}-y_{ZS} plane and is determined last of all as the rotation which is still necessary.

The conversion of the coordinates in the camera coordinate system to coordinates in the vehicle coordinate system takes place analogously using corresponding pitch, roll and yaw angles.

In the method of the invention video image points of the video image are associated with object points and/or corresponding distance image points detected with the laser scanner 14. For the description of the image forming characteristics of the camera which are required for this purpose a matt disk model is used (see FIG. 7). This is sufficient because in the example the video images are correspondingly treated to remove distortion prior to processing.

An object in the camera coordinate system (xᵥ, yᵥ, zᵥ) the origin of which lies on the focal point of the image forming system 36 is projected onto the image forming plane lying at the distance f from the focal point in which a Cartesian coordinate system with axes u and v is defined.

The image point coordinates (u, v) in pixel units of an object point with coordinates Xᵥ, Yᵥ und Zᵥ in the camera coordinate system can be recited with the aid of the beam laws, with the focal widths fᵤ and fᵥ quoted in image points and with the intersection point (u₀, v₀) of the zᵥ-axis with the matt disk:

$$u = {u}_{0} - \frac{{X}_{V}}{{Z}_{V}} {f}_{u}$$

$$v = {v}_{0} - \frac{{Y}_{V}}{{Z}_{V}} {f}_{v} .$$

The calibration is carried out in accordance with a method of a preferred embodiment of the invention in the following way.

In the first step the vehicle and the calibration surfaces, i.e. the calibration bodies 22₁ and 22ᵣ and also 24, 24′ and 24″ are so arranged relative to one another that the edge 52 of the central second calibration body 24′ lies on the longitudinal axis 45 of the vehicle and thus on the x-axis of the vehicle coordinate system. Furthermore, the two first calibration bodies 22₁ and 22ᵣ are arranged on opposite sides of the vehicle longitudinal axis 45 at an angle of approximately 45° to the latter.

In the following step a distance image and a video image of the scene is detected and pre-processed. During the pre-processing a rectification of the video image data can preferably be carried out, for example for the removal of distortions. The actual distance image and the actual video image are then stored for the further utilization.

In the following steps the determination of the orientation of the laser scanner 14 on the basis of the detected distance image first takes place in which the pitch angle and the roll angle are determined.

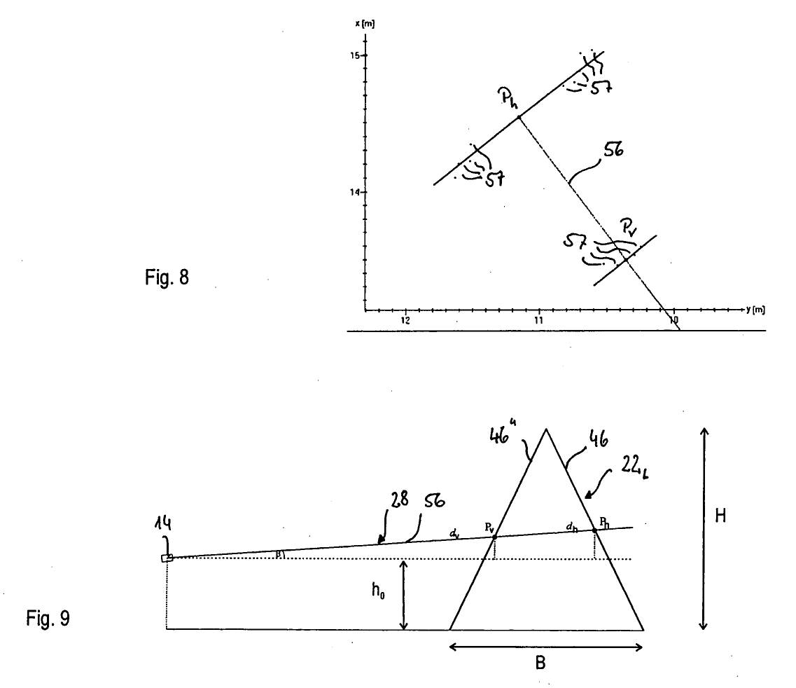

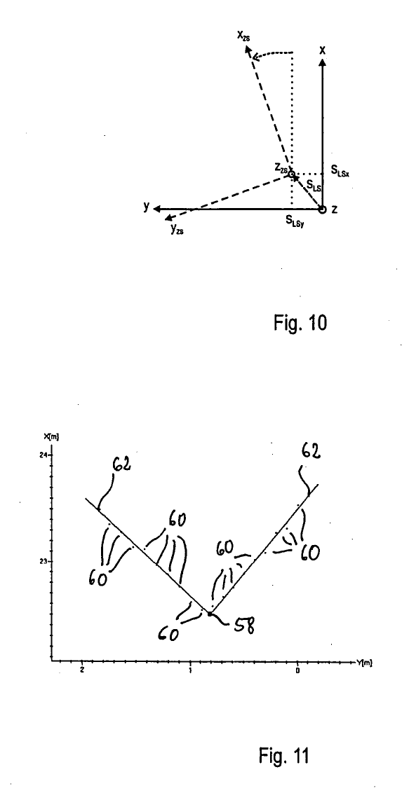

In one step the inclination of a scanning beam or of a virtual beam 56 going radially out from the laser scanner 14 in the scanned area is determined for the at least two calibration objects 22₁ and 22ᵣ (see FIGS. 8 and 9). This will be illustrated with respect to the example of the scanned area 28.

For this purpose the position of a rear reference point Pₕ is initially found for both calibration objects 22₁ and 22ᵣ respectively from the distance image points which correspond to regions on the respective two first calibration surfaces 46, 46′ inclined towards the laser scanner 14. Distance image points on the edges of the calibration surfaces are not taken into account for this purpose. Correspondingly, the position of a front reference point Pᵥ is determined from the distance image points which correspond to regions of the respective calibration surface 46″ inclined away from the laser scanner 14. The reference points Pₕ and Pᵥ in each case recite the height at which the scanned area 28 intersects the corresponding calibration surface 46, 46′ and 46″. Furthermore, they lie on a virtual scanning beam 56 which extends orthogonally to a straight regression line determined for the rear reference point Pₕ for the distance image points and to a straight regression line found for the distance image points for the front reference point Pᵥ and through the laser scanner 14 or the origin of the laser scanner coordinate system (see FIG. 8).

In each case straight regression lines (see FIG. 8) are determined from the distance image points 57 for the rear reference point Pₕ and from those for the front reference point Pᵥ, for example by linear regression. Then the points of intersections between the regression straight lines and a virtual beam 56 orthogonal to them and extending through the origin of the laser scanner coordinate system are determined as the rear and front reference points Pₕ and Pᵥ respectively (see FIG. 8). Through this type of determination of the position of the reference points Pₕ and Pᵥ the influence of inaccuracies in the angular determination during the detection of distance images is kept very low or removed.

For these reference points Pₕ and Pᵥ the distances dₕ and dᵥ from the origin of the laser scanner coordinate system and also the corresponding pivot angle α to be calculated from the coordinates in the laser coordinate system are thus known, or are easily found from the distance image points.

The front and the rear reference point furthermore have respective heights above the surface 12, i.e. above the vehicle coordinate system, caused by the different inclinations of the calibration surfaces 46, 46′ and 46″ respectively when the laser scanner 14, i.e. the scanned area does not extend precisely parallel to the x-y-plane of the vehicle coordinate system. If h₀ represents the spacing of the origin of the laser scanner coordinate system, i.e. of the scanned area from the vehicle coordinate system in the z direction, known through the installed position of the laser scanner 14 in the vehicle, then the following equation can be derived from FIG. 9 for the inclination β of the virtual beam 56 in the scanned area 28:

$$cos β = {c}_{1} + {c}_{2} \cdot sin β$$

$$with$$

$${c}_{1} = \frac{H - {h}_{0}}{{d}_{h} - {d}_{v}} \cdot \frac{B}{H} und {c}_{2} = \frac{{d}_{h} + {d}_{v}}{{d}_{h} - {d}_{v}} \cdot \frac{B}{2 H} .$$

This equation does not involve a predetermined distance of the calibration surfaces 46, 46′ and 46″ from the laser scanner 14 so that the calibration surfaces 46, 46′ and 46″ and the vehicle 10 do not need to observe any precisely preset relative position in this relationship.

In the method this equation is thus solved for the angle β using the known or determined values for dₕ, dᵥ, H, B and h₀ which can take place numerically. The values can, however, also be used alternatively in an analytically obtained solution of the equation.

In a subsequent step, when the scanned area 28 does not extend in the x_{LS}-y_{LS} plane of the laser scanner coordinate system the corresponding inclination of the laser scanner coordinate system in the direction set by the swivel angle α for the virtual beam can be approximately determined for small roll angles by substituting the value β′=β−ε(α) for the determined angle β, with ε(α) designating the inclination angle known for the laser scanner 14 and the scanned area 28 which is used between a beam along the scanned area 28 and the x_{LS}-y_{LS} plane of the laser scanner coordinate system at the swivel angle α.

After this step β′ thus gives the inclination of the laser scanner coordinate system for the corresponding calibration object along the direction α in the laser scanner coordinate system.

Thus, respective angles of inclination β₁ and βᵣ of the scanned area 28 in the directions α₁ and αᵣ are found in the laser scanner coordinate system for the two calibration surfaces 22₁ and 22ᵣ to the left and right of the reference line 44, which can be used in the further steps.

In the subsequent step the angles ∂_{LS} und φ_{LS} to the intermediate coordinate system and/or to the vehicle coordinate system are calculated from the two angles of inclination β₁′ and βᵣ′ in the directions α₁ and αᵣ in the laser scanner coordinate system. As has already been described previously the laser coordinate system proceeds from the intermediate coordinate system in that the latter is first rotated by the angle φ_{LS} about x_{ZS}-axis and then by the angle ∂_{LS} about the rotated y_{ZS}-axis.

The formula used for this purpose can for example be obtained in the following way. Two unit vectors in the laser scanner coordinate system are determined which extend in inclined manner in the directions α₁ and αᵣ respectively and parallel to the x_{ZS}-y_{ZS} plane of the intermediate coordinate system, i.e. with the angles of inclination β₁′ and βᵣ′ respectively relative to the x_{LS}-y_{LS}-plane of the laser scanner coordinate system. The vector product of these unit vectors corresponds to a vector in the z_{LS} direction of the intermediate coordinate system the length of which is precisely the sine of the angle between the two unit vectors. The vector product calculated in the coordinates of the laser scanner coordinate system is transformed into the intermediate coordinate system in which the result is known. From the transformation equation one obtains the following formulae for the roll angle φ_{LS}

$${φ}_{LS} = - arc sin \frac{cos {α}_{1} cos {β}_{l}^{′} sin {β}_{r}^{′} - cos {α}_{r} cos {β}_{r}^{′} sin {β}_{l}^{′}}{{( 1 - {( \begin{matrix}cos {α}_{l} cos {β}_{l}^{′} cos {α}_{r} cos {β}_{r}^{′} + \\ sin {α}_{l} cos {β}_{l}^{′} sin {α}_{r} cos {β}_{r}^{′} + \\ sin {β}_{l}^{′} sin {β}_{r}^{λ}\end{matrix} )}^{2} )}^{1 / 2}}$$

$$and for the pitch angle {ϑ}_{LS}$$

$${ϑ}_{LS} = - arctan \frac{sin {α}_{l} cos {β}_{l}^{′} sin {β}_{r}^{′} - sin {α}_{r} cos {β}_{r}^{′} sin {β}_{l}^{′}}{cos {β}_{l}^{′} cos {β}_{r}^{′} sin ( {α}_{r} - {α}_{l} )} .$$

Although the values for the pitch angle and for the roll angle depend on the calculated swivel angles α₁ and αᵣ respectively it is essentially distance information which is used for the derivation because the reference points are found essentially on the basis of distance information.

In the method it is only necessary to insert the corresponding values into these formulae.

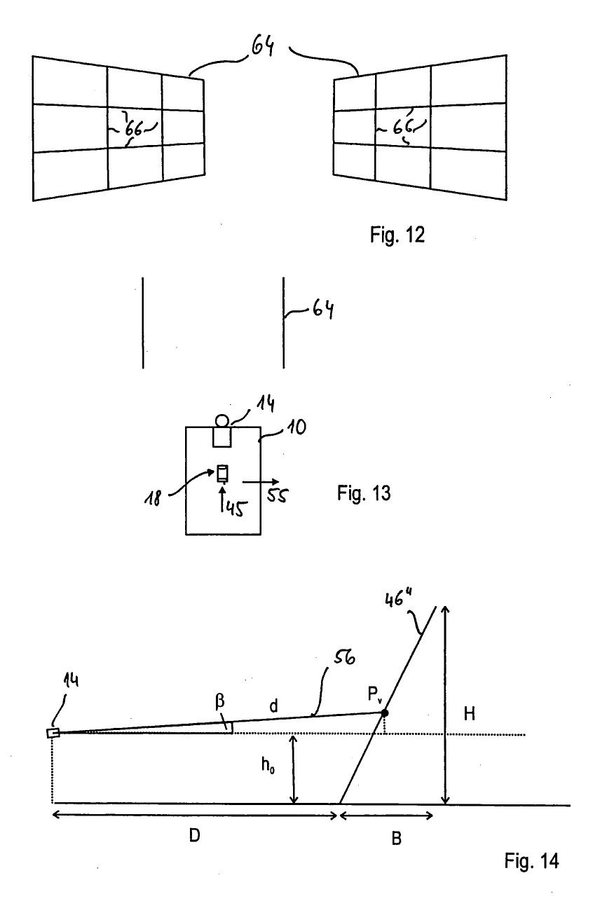

In the next steps the remaining yaw angle Ψ_{LS} is found using the second calibration object 24 arranged on the longitudinal axis 45 of the vehicle (see FIGS. 11 and 12).

For this purpose a reference point 58 of the second calibration object 24 is first found which is given by the intersection of two contour lines on the second calibration surfaces 50 and 50′. The contour lines are determined by the distance image points detected on the second calibration surfaces taking account of the known shape of the calibration surfaces, i.e. the intersection of the scanned area with the second calibration surfaces 50 and 50′.

The reference point 58 results through the intersections of the scanned area 28 with the straight intersection line of the flat second calibration surfaces 50, 50′ and by the intersection point of the straight regression lines 62 corresponding to contour lines through the distance image points 60 of regions extending on the second calibration surfaces 50, 50′. For this purpose straight regression lines are placed in the laser coordinate system through the corresponding distance image points 62 by means of linear regression for which the point of intersection is then found. In doing this distance image points on edges are also not used (see FIG. 12).

The coordinates of the so found reference points 58 are then converted using the roll angle values and pitch angle values determined in coordinates in the intermediate coordinate system. For the determination of the yaw angle the fact is exploited that the position of reference point 58 in the y-direction of the vehicle coordinate system is known: the edge lies on the straight reference line 44 and thus directly on the longitudinal axis of the vehicle, on the x-axis, and therefore has the y-coordinate 0. The x-coordinate is designated with X, does not however play any role in the following. Using the relationship

$$( \begin{matrix}{X}_{ZS} \\ {Y}_{ZS}\end{matrix} ) = {R}_{ψ} ( {s}_{LS} + ( \begin{matrix}X \\ 0\end{matrix} ) )$$

between the coordinates (X_{ZS}, Y_{ZS}) of the reference point in the intermediate coordinate system and the coordinates (X, 0) in the vehicle coordinate system with the shift vector s_{LS}=(s_{LSx}, s_{LSy}) known through the installation position of the laser scanner 14 between the coordinate origins of the vehicle coordinate system and of the intermediate coordinate system the following equation for the yaw angle Ψ_{LS} can than be obtained.
Y_{ZS} cos Ψ_{LS}=s_{LSy}+X_{ZS} sin Ψ_{LS}.

In the method this equation is solved analogously to the determination of the inclination numerically or analytically for the value Ψ_{LS}.

Thus the orientation of the laser scanner 14 relative to the vehicle coordinate system is fully known.

In another embodiment the actual angle between a plane perpendicular to the x_{LS}-y_{LS}-plane of the laser scanner coordinate system in which the angle ε lies and the plane perpendicular to the x-y-plane of the vehicle coordinate system in which the angle β is determined are taken into account more precisely. For this purpose, starting values for the pitch angle and a roll angle are calculated starting from the value derived in accordance with the first embodiment. With these values the alignment of the plane in which the angle ε lies and of the plane perpendicular to the x-y-plane of the vehicle coordinate system in which the angle β is determined is then determined by means of known trigonometric relationships. With the known alignment the angle ε or β′ can now be determined to a first approximation. On this basis new values for the pitch angle and for the roll angle are found. The alignment can be determined very precisely by iteration, in which the values for the pitch angle and the roll angle respectively convert towards a final value.

On the basis of the known orientation of the laser scanner 14 the orientation of the video camera 18 relative to the laser scanner 14 and thus to the vehicle coordinate system can now take place.

For this purpose the position of at least two calibration features in the vehicle coordinate system is found on the basis of the distance image detected by means of the laser scanner 14 and transformed into the vehicle coordinate system. These calibration features are transformed using the known position of the video camera 18 in the vehicle coordinate system and assumed angle of rotation for the transformation from the vehicle coordinate system into the camera coordinate system. By way of the camera model the position of the corresponding calibration features determined on the basis of the distance image is then found in the video image.

These positions in the video image found by means of the distance image are compared with the actually determined positions in the video image in the u-v-plane.

Using a numerical optimization process, for example a process using conjugated gradients the angle of rotation for the coordinate transformation between the vehicle coordinate system and the camera coordinate system is so optimized that the average square spacings between the actual positions of the calibration features in the video image and the positions predicted on the basis of the distance image are minimized or the magnitude of the absolute or relative change of the angle of rotation falls below a predetermined threshold value.

In the example the crossing points of the pattern on the third calibration surfaces 54 or calibration panels are then used as calibration features. The positions are determined in this respect from the distance images in that the position of the reference points on the x-y-plane of the vehicle coordinate system is found in the vehicle coordinate system and is used as the z-coordinate of the known spacing of the crossing points from the surface 12 or from the x-y-plane of the vehicle coordinate system.

The crossing points can be found simply in the video image with respect to preset templates.

The calibration of the laser scanner and of the video camera can also be carried out independently from one another.

In another embodiment, in the derivation of the pitch angle and of the roll angle on the basis of the determined inclinations of the virtual beams, the coordinates of the front or rear reference points on the laser scanner coordinate system and also the z component of the position in the vehicle coordinate system are found. On the basis of the coordinate transformations the pitch angle and the roll angle can then be found.

In a further embodiment walls extending parallel in a production line for the vehicle 10 are used as the second calibration surfaces 64 on which parallel extending net lines 66 are applied as calibration features for the calibration of the alignment of the video camera 16 (see FIGS. 12 and 13).

For the determination of the yaw angle straight regression lines extending on the second calibration surfaces 64 and their angle relative to the longitudinal axis 45 of the vehicle, which corresponds to the yaw angle, are again determined by using distance image points on the second calibration surfaces 64. Here also it is essentially distance data that is used so that errors in the angular determination are not significant.

In a third embodiment only two first calibration surfaces spaced apart from another transverse to the longitudinal axis of the vehicle are used which are respectively inclined in the same way as the first calibration surface 46″.

For each of the first calibration surfaces 46″ the position of a reference point Pᵥ in its z-direction of the vehicle coordinate system determined in accordance with the first embodiment can be found with a known preset distance D of the respective calibration surface 46″ from the laser scanner 14 (see FIG. 14). In the laser scanner coordinate system this point has the z_{LS}-coordinate 0. The equation

$$cos β = \frac{{h}_{0}}{d} - \frac{DH}{d B} - \frac{H}{B} sin β$$

applies, i.e. after the determination of β as in the first embodiment
z=h₀+d·sin β.

Thus three points for the x_{LS}-y_{LS}-plane, the two reference points of the calibration surfaces and the origin of the laser scanner coordinate system are known so that the pitch angle and the roll angle can be determined from them.

In a fourth embodiment the distance image points in two scanned areas are used together with the just described calibration surfaces, whereby the inclination of the corresponding virtual beams relative to the surface 12 and from this the pitch angle and roll angle can be found.

### Reference Numeral List

10 vehicle

12 surface

14 laser scanner

16 video system

18 video camera

20 date processing device

22₁, 22ᵣ first calibration objects

24, 24′, 24″ second calibration objects

26 detection range

28, 28′, 28″, 28′″ scanned areas

30 laser beam

32 object point

34 CCD-area sensor

36 image forming system

38 optical axis

40 video detection range

42 monitoring range

44 reference line

45 longitudinal axis of vehicle

46, 46′, 46″ first calibration surfaces

48 vertical axis of vehicle

50, 50′ second calibration surfaces

52 edge

54 third calibration surface

55 transverse axis of the vehicle

56 virtual scanning beam

57 distance image points

58 reference point

60 distance image points

62 straight regression lines

64 second calibration surfaces

66 net lines

The description of the invention is merely exemplary in nature and, thus, variations that do not depart from the gist of the invention are intended to be within the scope of the invention. Such variations are not to be regarded as a departure from the spirit and scope of the invention.

1. Method for the at least partial calibration of a distance image sensor (14) for electromagnetic radiation mounted on a vehicle (10) by means of which a detection range (26) along at least one scanned area (28, 28′, 28″, 28′″) can be scanned and a corresponding distance image can be detected in relation to an alignment of the scanned area (28, 28′, 28″, 28′″) or of the distance image sensor (14) relative to the vehicle (10), wherein distances between the distance image sensor (14) and regions on at least one calibration surface (46, 46′, 46″, 50, 50′) are found by means of the distance image sensor (14) and a value for a parameter which at least partly describes the alignment is determined using the distances that are found.

2. Method in accordance with claim 1,
characterized in that
a calibration surface (46, 46′, 46″, 50, 50′) with a known shape is used on which at least two neighbouring regions along the scanned area (28, 28′, 28″, 28′″) can be detected in spatially resolved manner for the calibration by means of the distance image sensor (14).

3. Method in accordance with claim 1,
characterized in that
a distance image sensor (14) is calibrated by means of which the detection region (26) can be scanned along at least two different scanned areas (28, 28′, 28″, 28′″).

4. Method in accordance with claim 1,
characterized in that
a distance image sensor (14) is calibrated for which the position and/or the alignment of the scanned area (28, 28′, 28″, 28′″) relative to a coordinate system of the distance image sensor (14) is known, in that coordinates in a coordinate system of a distance image sensor (14) are determined for distance image points of the detected distance image which are associated with the scanned area (28, 28′, 28″, 28′″) and in that these coordinates are used for the at least partial determination of the alignment.

5. Method in accordance with claim 3,
characterized in that
respectively detected regions in the two scanned areas (28, 28′, 28″, 28′″) are jointly used for the at least partial determination of the alignment.

6. Method in accordance with claim 3,
characterized in that
for each of the scanned areas (28, 28′, 28″, 28′″) a value associated with the respective scanned area (28, 28′, 28″, 28′″) for the parameter which at least partly reproduces the alignment is determined from the distances of detected regions on the calibration surface (46, 46′, 46″, 50, 50′) to the distance image sensor (14) and in that a value for the parameter which at least partly reproduces the alignment of the distance image sensor (14) is determined from the values associated with the scanned areas (28, 28′, 28″, 28′″).

7. Method in accordance with claim 1,
characterized in that
the calibration surface (46, 46′, 46″, 50, 50′) is flat.

8. Method in accordance with claim 1,
characterized in that
the regions of the calibration surface (46, 46′, 46″) are respectively inclined relative to the longitudinal axis or vertical axis of the vehicle in a predetermined manner for the at least partial determination of an orientation of the scanning area (28, 28′, 28″, 28′″) or of the distance image sensor (14) relative to the vehicle (10), in particular of a pitch angle, and in that a value for a parameter which at least partly reproduces the orientation, in particular the pitch angle, is determined from the detected distances of the detected distances of the regions detected by the distance image sensor (14) in dependence on their inclinations.

9. Method in accordance with claim 1,
characterized in that
a distance of the calibration surface (46, 46′, 46″) from the distance image sensor (14) in the range of scanned area (28, 28′, 28″, 28′″) is determined from at least two detected distances of the regions of the calibration surface (46, 46′, 46″) and
in that a value for a parameter which at least partly reproduces the orientation of the scanned area (28, 28′, 28″, 28′″) or of the distance image sensor (14), in particular the pitch angle, is determined using the determined distance of the calibration surface (46, 46′, 46″).

10. Method in accordance with claim 1,
characterized in that
for the at least partial determination of the orientation, in particular of the pitch angle, two calibration surfaces (46, 46′, 46″) arranged adjacent to one another in a predetermined position are used whose regions are used for the calibration are inclined in different, predetermined, manner relative to the longitudinal axis or the vertical axis of the vehicle; in that distances between the distance image sensor (14) and regions on the calibration surfaces (46, 46′, 46″) close to the scanned area (28, 28′, 28″, 28′″) are determined by means of the distance image sensor (14) and in that differences of the distances that are determined are used for the determination of a value for a parameter which at least partly reproduces the orientation of the scanned area (28, 28′, 28″, 28′″) or of the distance image sensor (14), in particular the pitch angle.

11. Method in accordance with claim 1,
characterized in that
for the determination of the orientation at least two calibration surfaces (46, 46′, 46″) which are spaced from one another in a direction transverse to a beam direction of the distance image sensor (14) are used on which regions are respectively inclined in a predetermined manner relative to the longitudinal axis or vertical axis of the vehicle.

12. Method in accordance with claim 11,
characterized in that
an angle between connecting lines between the calibration surfaces (46, 46′, 46″) and the distance image sensor (14) lies between 5° and 180°.

13. Method in accordance with claim 1,
characterized in that
the values of the parameters which describe the orientation are determined in dependence on one another.

14. Method in accordance with claim 1,
characterized in that
for the determination of a rotation of a reference direction in the scanned area (28, 28′, 28″, 28′″) or of a reference direction of the distance image sensor (14) at least approximately about the vertical axis of the vehicle, or about a normal to the scanned area (28, 28′, 28″, 28′″), at least one calibration surface (50, 50′) is used, the form and alignment of which relative to a reference direction of the vehicle (10) is predetermined,
in that the positions of at least two regions on the calibration surface (50, 50′) are determined by means of the distance image sensor (14) and in that a value of a parameter which reproduces the angle of the rotation, in particular of a yaw angle, is determined in dependence on the positions that are found.

15. Method in accordance with claim 14,
characterized in that
two calibration surfaces (50, 50′) are used, the shape of which is predetermined and which are inclined relative to one another in a plan parallel to a surface (12) on which the vehicle (10) stands with the alignment of at least one of the calibration surfaces (50, 50′) relative to the reference direction of the vehicle (10) being predetermined,
in that the positions of at least two regions on each of the calibration surfaces (50, 50′) are in each case determined by means of the distance image sensor (14) and
in that the value of the parameter is determined in dependence on the positions.

16. Method in accordance with claim 14,
characterized in that
two calibration surfaces (50, 50′) are used, the shape of which and the position of which relative to one another and at least partly to the vehicle (10) is predetermined and which are inclined relative to one another in the sections in the direction towards a surface (12) on which the vehicle (10) stands, and in that at least two distance image points are determined by means of the distance image sensor (14) on each of the calibration surfaces (50, 50′) and the position of a reference point set by the calibration surfaces (50, 50′) is determined on the basis of the detected positions of the distance image points, the shape of the calibration surfaces (50, 50′) and the relative positions of the calibration surfaces (50, 50′) to one another and to the vehicle (10) and is set into relationship with a predetermined desired position.

17. Method in accordance with claim 16,
characterized in that
contour lines on the calibration surfaces (50, 50′) are determined by means of the distance image points that are detected and
the position of the reference point is determined from the contour lines.

18. Method in accordance with claim 16,
characterized in that
the calibration surfaces are flat and
in that the reference point lies on an intersection line of the planes set by the calibration surfaces (50, 50′).

19. Method in accordance with claim 1,
characterized in that
a video camera (18) is calibrated for the detection of video images of at least a part of the detection range (26) of the distance image sensor (14), at least partly in relationship to an alignment relative to the distance image sensor (14) and/or to the vehicle (10) in that the position of a surface (54) for the video calibration is determined by means of the distance image sensor (14) taking account of the calibration of the distance image sensor (14), the position of a calibration feature on the surface (54) is detected by means of the video camera for the video calibration and the value of a parameter which at least partly reproduces the alignment is determined from the position of the calibration feature in the video image and the position of the surface (54) for the video calibration.

20. Method in accordance with claim 19,
characterized in that
a position of the calibration feature in the image is determined in dependence on position coordinates of the calibration feature determined by means of the distance image sensor (14) by means of a rule for the imaging of beams in the three-dimensional space onto a sensor surface of the video camera (18), preferably by means of a camera model.

21. Method in accordance with claim 19,
characterized in that
the surface (54) for the video calibration is arranged in a known position relative to the calibration surfaces (50, 50′) for the determination of a rotation of a reference direction in the scanned area (28, 28′, 28″, 28′″) or of a reference direction of the distance image sensor (14) at least approximately about the vertical axis of the vehicle or about a normal to the scanned area (28, 28′, 28″, 28′″) and is in particular associated with these.

22. Method in accordance with claim 19,
characterized in that
the calibration feature is formed on one of the calibration surfaces (50, 50′).

23. Method in accordance with claim 19,
characterized in that
internal parameters of a camera model of the video camera (18) are determined by means of the calibration feature.
